(19) United States
(12) Patent Application Publication
(10) Pub. No.: US 2022/0245615 A1
(43) Pub. Date: Aug. 4, 2022

(54) Mobile point-of-sale and social marketplace

(71) Applicant: Bazar Enterprises, LLC, Artesia, CA (US)

(72) Inventor: Madhav Krishan Soni, Thousand Oaks, CA (US)

(21) Appl. No.: 17/588,362

(22) Filed: Jan. 31, 2022

Related U.S. Application Data
(60) Provisional application No. 63/143,293, filed on Jan. 29, 2021.

(51) Int. Cl. G06Q 20/32

(52) U.S. Cl. CPC G06Q 20/3274

(57) ABSTRACT

Bazar is a Mobile Point of Sale and Social Marketplace. The present invention consolidates core components from marketplace, point of sale, and social media systems, and uniquely connects the three high level systems through a pair of mobile applications, a merchant-facing application and a customer-facing application. Customers may view and socially interact with custom mobile shops with at least six different order capabilities provided by the App including Cash, Standard, Ticket, Pick Up, Near By, and At Home. Merchants may manage such shop, socially interact with customers, and fulfill orders using authentication mechanisms that require proof of fulfillment.

### FIELD OF THE INVENTION

The present invention is related to a mobile sales system and method that enables merchants to accept payments and connect to their customers through a pair of mobile applications, a merchant-facing application and a customer-facing application and more particularly to a custom mobile shop having at least six different ordering capabilities provided by the App, Cash, Standard, Ticket, Pick Up, Near By, and At Home.

### BACKGROUND OF THE INVENTION

It is common practice to accept payments through point-of-sale systems including mobile device applications. For example, a restaurant may use a customer-facing mobile application to accept Pick-Up food orders. A customer selects food products for purchase on the app and pays for the order. Order information is stored on a server and the customer is provided with a unique identification token or receipt number. A merchant may read in the token or receipt number using their merchant-facing application and use this identifier to retrieve the order information from the server.

While this technique creates value by preprocessing an order, it comes at primarily two costs: higher transaction fees associated with online payment gateways and server storage. Payments made through an online portal are more costly than payments made through in person credit card readers. The present invention advantageously leverages the less costly credit card payment methodology while simultaneously providing value created from pre-processing the product selection and receipt delivery processes. Additionally, rather than create an entire representation of an order on the server, the present invention creates a local representation of a dataset abstraction of a non-recorded order. Value is thus conserved in the present invention by minimizing resource usage of this highly scalable and frequently used process.

### SUMMARY OF THE INVENTION

It is therefore an objective of the present invention to provide an application-base mobile point-of-sale system that leverages the less costly credit card payment methodology while simultaneously providing value created from pre-processing the product selection and receipt delivery processes. Additionally, rather than create an entire representation of an order on the server, the present invention creates a local representation of a dataset abstraction of a non-recorded order. Value is thus conserved by minimizing resource usage of this highly scalable and frequently used process.

The present invention (“Bazar™”, “the Bazar™ App”, “the App”, “the application”) is combining a mobile point-of-sale and marketplace that enables merchants to accept payments and connect to their customers through a pair of mobile applications, a merchant-facing application and a customer-facing application. The present invention provides a mobile sales system, comprising a user device, a merchant server, an image acquisition device operatively connected to a point-of-sale device. The user device is configured to receive a user input including item selection with a merchant and obtain the user payment information. The user device is also enabled to generate a purchase transaction request including user payment information and provide the purchase transaction request to the merchant server. The user device having ability to obtain an electronic purchase receipt and also generate a payment code image including information from the electronic purchase receipt. Further, the user device is configured to display the payment code image, via a display operatively connected to the user device.

The image acquisition device is configured to acquire an image of the payment code image and extract data from the payment code image at the point-of-sale device. The image acquisition device is also configured to confirm the information from the electronic purchase receipt by the point-of-sale device to complete the purchase transaction.

In one exemplary embodiment, the user device is a mobile device. The user input is a touchscreen gesture on a touchscreen operatively connected to the user device.

In another exemplary embodiment, the payment code is at least a one or more one-dimensional barcode, a two-dimensional barcode and a Quick Response code.

In another exemplary embodiment, the merchant is an online marketplace merchant. The electronic purchase receipt includes a merchant identifier and a session identifier for a user shopping session with a merchant associated with the merchant identifier.

In another exemplary embodiment, the user payment information is associated with a virtual wallet account. The point-of-sale terminal is located at a physical merchant store.

In one exemplary embodiment, the present invention provides a computer-implemented mobile sales method, comprising obtaining at a user device, a user checkout request. The computer-implemented mobile sales method is configured for obtaining a user shopping cart information with a merchant related to the user checkout request, and generating via the user device, a payment code image containing information including the user shopping cart information encoded in the payment code image. The computer-implemented mobile sales method is configured for displaying the payment code image, via a display operatively connected to user device, acquiring, by the point-of-sale device, via an image acquisition device operatively connected to the point-of-sale device, an image of the payment code image, transforming the image into data encoded in the payment code image. The computer-implemented mobile sales method is configured for obtaining at the point-of-sale device, user payment information, after the step of acquiring, generating, via the point-of-sale device, a purchase transaction request including the data and providing the purchase transaction request to a server by the point-of-sale device. Further the computer-implemented mobile sales method is configured for obtaining by the point-of-sale device, a notification of authorization of the purchase transaction and obtaining an electronic purchase receipt for the purchase transaction.

In another exemplary embodiment, the shopping cart information includes account information.

In another exemplary embodiment, the step of obtaining, at the point-of-sale device, user payment information includes obtaining user payment information from the data.

In another exemplary embodiment, the step of displaying the payment code image includes obtaining, at the user device, a user input is to display the payment code image wherein the user input is a touchscreen gesture on a touchscreen is operatively connected to the user device.

In yet another exemplary embodiment, the notification of authorization of the purchase transaction includes an identifier of the user shopping cart information.

In yet another exemplary embodiment, the notification of authorization of the purchase transaction further comprises a session identifier that includes a token parameter in a uniform resource locator for the user shopping cart information.

In another exemplary embodiment, the notification of authorization of the purchase payment information is associated with a virtual wallet account.

In yet another exemplary embodiment, the present invention provides a mobile sales system comprising a merchant server, an image acquisition device operatively connected to a point-of-sale device, and a user device configured to receive a user request to search for a product with a merchant. The mobile sales system further comprises a customer engagement module configured to receive a user request to view a product parameter associated with the merchant, and a messaging module configured to provide a communication channel between a user and the merchant to exchange messages associated with the product. The user device is configured to receive a user input including a product selection with the merchant, obtain user payment information, generate a purchase transaction request including user payment information, provide the purchase transaction request to the merchant server, obtain an electronic purchase receipt, generate a payment code image including information from the electronic purchase receipt and display the payment code image, via a display operatively connected to the user device. The image acquisition device is configured to acquire an image of the payment code image, extract data from the payment code image at the point-of-sale device and confirm the information from the electronic purchase receipt by the point-of-sale device to complete the purchase transaction.

The user device is configured to receive a user checkout request, obtain user shopping cart information with the merchant related to the user checkout request, generate a payment code image containing information including the user shopping cart information encoded in the payment code image, and display the payment code image, via the display operatively connected to the user device. The point-of-sale device is configured to acquire an image of the payment code image via the image acquisition device operatively connected to the point-of-sale device, transform the image into data encoded in the payment code image, obtain the user payment information, generate a purchase transaction request including the data, and provide the purchase transaction request to the merchant server. Further, the point-of-sale device is configured to obtain a notification of authorization of the purchase transaction and obtain an electronic purchase receipt for the purchase transaction.

In one exemplary embodiment, the user is enabled to search for the product based on the product category, product tags, product popularity, and product features. The product parameter is at least one of a product image, product video, product information, product stories, product price, likes, dislikes and comments on the product.

In one exemplary embodiment, the customer engagement module enables the user to like, dislike and/or comment on the viewed product. The messaging module is configured to provide the communication channel between the user and the merchant to exchange messages associated with the product price, user's past orders, complaints, questions related to the product, or any other product related query.

### BRIEF DESCRIPTION OF THE DRAWINGS

The objects, features and advantages of the present invention will be more readily appreciated upon reference to the following disclosure when considered in conjunction with the accompanying drawings, in which:

FIG. 1 is a screenshot of an illustrative user interface in a custom mobile shop for a Home Screen, in accordance with an exemplary embodiment of the present invention.

FIG. 2 illustrates an exemplary user interface for a Merchant Shop and Product Detail Page installed on a mobile user device, in accordance with an exemplary embodiment of the present invention.

FIG. 3 is a screenshot of an illustrative user interface in a Bazar customer mobile shop for a selected product, in accordance with an exemplary embodiment of the present invention.

FIG. 4 and FIG. 4A illustrates an exemplary user interface for a Single Cart View and Multi Cart View, in accordance with an exemplary embodiment of the present invention.

FIG. 5 is a screenshot of an illustrative user interface in a custom mobile shop for a pre-checkout page, in accordance with an exemplary embodiment of the present invention.

FIG. 6 is a screenshot of an illustrative user interface of a pre-checkout page with ticket method selected, in accordance with an exemplary embodiment of the present invention.

FIG. 7 is a screenshot of an illustrative user interface of a pre-checkout page with Pick-Up method selected, in accordance with an exemplary embodiment of the present invention.

FIG. 8 is a screenshot of an illustrative user interface of a pre-checkout page with Near By method selected, in accordance with an exemplary embodiment of the present invention.

FIG. 9 is a screenshot of an illustrative user interface of a pre-checkout page with At Home method selected, in accordance with an exemplary embodiment of the present invention.

FIG. 10 is a screenshot of an illustrative user interface of a ticket method screen, in accordance with an exemplary embodiment of the present invention.

FIG. 11 is a screenshot of an illustrative user interface in a custom mobile shop for a Pick-Up Detail information screen, in accordance with an exemplary embodiment of the present invention.

FIG. 12 illustrates an exemplary user interface for the payment page, in accordance with an exemplary embodiment of the present invention.

FIG. 13 are the screenshots of an illustrative user interface in a custom mobile shop for a Nearby Delivery Details Page, in accordance with an exemplary embodiment of the present invention.

FIG. 14 and FIG. 15 are screenshots of an illustrative user interface in a custom mobile shop for a Home Delivery Details Screen, in accordance with an exemplary embodiment of the present invention.

FIG. 16 is a screenshot of an illustrative user interface for a Home Delivery Details Page, in accordance with an exemplary embodiment of the present invention.

FIG. 17 is a screenshot of an illustrative user interface for At Home Payment Page, in accordance with an exemplary embodiment of the present invention.

FIG. 18 is a screenshot of an illustrative user interface for a receipt, in accordance with an exemplary embodiment of the present invention.

FIG. 19 illustrates an exemplary user interface for a Bazar Merchant Home Screen, in accordance with an exemplary embodiment of the present invention.

FIG. 20 illustrates an exemplary user interface for a Bazar merchant shop screen, in accordance with an exemplary embodiment of the present invention.

FIG. 20A shows a camera scanner of the merchant, in accordance with an exemplary embodiment of the present invention.

FIG. 21 illustrates an exemplary user interface for a demonstration of the merchant cart, in accordance with an exemplary embodiment of the present invention.

FIG. 22 is a screenshot of an unfulfilled orders for At Home, Near By, and Pick Up order methods, in accordance with an exemplary embodiment of the present invention.

FIG. 23 is a screenshot of an illustrative user interface of receipt of an unfulfilled order, in accordance with an exemplary embodiment of the present invention.

FIG. 24 is a screenshot of an illustrative user interface of Receipt of an Unfulfilled Order for the At Home method, in accordance with an exemplary embodiment of the present invention.

FIG. 25 are the screenshots of an illustrative user interface for the movement from an unfulfilled order to a fulfilled order in the At Home order method, in accordance with an exemplary embodiment of the present invention.

FIG. 26 are the screenshots of a fulfillment image demonstration merchant view and the customer view, in accordance with an exemplary embodiment of the present invention.

FIG. 27 are screen shots of an illustrative user interface in a custom mobile shop for list of store permissions, in accordance with an exemplary embodiment of the present invention.

FIG. 28 illustrates an exemplary user interface of the shop menu, in accordance with an exemplary embodiment of the present invention.

FIG. 29 illustrates an exemplary user interface for an administrative order history page, in accordance with an exemplary embodiment of the present invention.

FIG. 30 is a screen shot of an illustrative user interface of sample unfulfilled order, in accordance with an exemplary embodiment of the present invention.

FIG. 31 is a screen shot of an illustrative user interface of custom mobile shop for invite employee of two different permission levels, in accordance with an exemplary embodiment of the present invention.

FIG. 32 illustrates a BBPOS credit card reader, in accordance with an exemplary embodiment of the present invention.

FIG. 33 illustrates an exemplary user interface At Home delivery fulfillment (3300), in accordance with an exemplary embodiment of the present invention.

FIG. 34 is a screen shot of a shop story (3400), in accordance with an exemplary embodiment of the present invention.

FIG. 35 is a screen shot of an illustrative user interface for the explore tab (3500), in accordance with an exemplary embodiment of the present invention.

FIG. 36 is a screen shot of an illustrative user to enter current location (3600), in accordance with an exemplary embodiment of the present invention.

FIG. 37 is a screen shot of an illustrative user interface for categories (3700), in accordance with an exemplary embodiment of the present invention.

FIG. 38 is a screen shot of an illustrative user interface for customers to view favorited shops (3800), in accordance with an exemplary embodiment of the present invention.

FIG. 39 is a screen shot of a shop editor (3900), in accordance with an exemplary embodiment of the present invention.

FIG. 40 is a screen shot of service charges (4000), in accordance with an exemplary embodiment of the present invention.

FIG. 41 is a screen shot of an illustrative user interface for story creation and editing page (4100), in accordance with an exemplary embodiment of the present invention.

FIG. 42 illustrates an exemplary user interface for Merchant Shop Reporting (4200), in accordance with an exemplary embodiment of the present invention.

FIG. 43 illustrates an exemplary user interface for Refund Order (4300), in accordance with an exemplary embodiment of the present invention.

FIG. 44 illustrates an exemplary user interface for force fulfillment (4400), in accordance with an exemplary embodiment of the present invention.

FIG. 45 is a screenshot for a review page (4500), in accordance with an exemplary embodiment of the present invention.

FIG. 46 are screenshots for an exemplary contact page without and with the optional fields (4600), in accordance with an exemplary embodiment of the present invention.

FIG. 47 illustrates an exemplary user interface for an exemplary policies page (4700), in accordance with an exemplary embodiment of the present invention.

FIG. 48 is a block diagram of a mobile sales system (4800), in accordance with an exemplary embodiment of the present invention.

### DETAILED DESCRIPTION OF THE INVENTION

While the present invention is susceptible of embodiment in many different forms, there are shown in the drawings and will be described herein in detail specific embodiments thereof, with the understanding that the present disclosure is to be considered as an exemplification of the principles of the invention and is not intended to limit the invention to the specific embodiments illustrated.

The present invention (“Bazar™”, “the Bazar™ App”, “the App”, “the application”) is combination of a mobile Point-of-Sale and marketplace that enables merchants to accept payments and connect to their customers through a pair of mobile applications, a merchant-facing application and a customer-facing application.

The merchant-facing application enables a merchant to create a custom mobile shop to upload, edit, create, and present the merchant's products/services. A merchant can select how to fulfill customer orders from at least six different ordering capabilities provided by the App: Cash, Standard, Ticket, Pick Up, Near By, and At Home. Cash orders involve an exchange of product/service for physical currency. Standard and Ticket orders utilize a credit card reader to fulfill payments, whereas Pick Up, Near By, and At Home orders utilize an online payment portal to make payments, which are then fulfilled by the merchant. The merchants may add optional service charges, such as shipping and tax charges, to Pick Up, Near By, and At Home fulfillment options. For the At Home fulfillment option, radius-based delivery charges may be applied in order to incentivize customers to buy products locally. Additionally, merchants may request an optional Tip from customers on Pick-Up, Near By, and At Home fulfillment options.

The present invention is embodied in an application installable on any device including but not limited to one or more processing device, mobile communication device (e.g., a smartphone/phone, tablet, laptop, personal digital assistant, etc.), a computer, a network, or the cloud. The application is output through a display such as a screen. Device input may occur on the client device through but not limited to a touch pad, buttons, or a mouse and information may be processed or accessed from other devices in a network (e.g., server devices, network appliances, other client devices, etc.). The device may include underlying components not limited to a microprocessor (CPU) such as RAM or ROM and an operating system. The Bazar mobile applications are software installed onto a device and configured to operate with input. One skilled in the art will appreciate that the scale of systems may vary and include additional or fewer components than those described.

A payment method embodied in an application installable on a mobile device is provided. The payment method generates a QR code representation of a customer's shopping cart. The QR code is scannable by a merchant to fulfill the customer's order. Rather than creating an entire representation of an order and uploading it on a server, the application creates a local representation on the mobile device of a dataset abstraction of the non-recorded order. The abstract representation of the order is represented as a QR code, bar code, or any other scannable abstract representation.

The QR code is displayed on the mobile device, presented to the merchant and scanned by the merchant using a camera scanner which reads in the QR code, converts the dataset into a readable format, and displays the information onto the merchant's application.

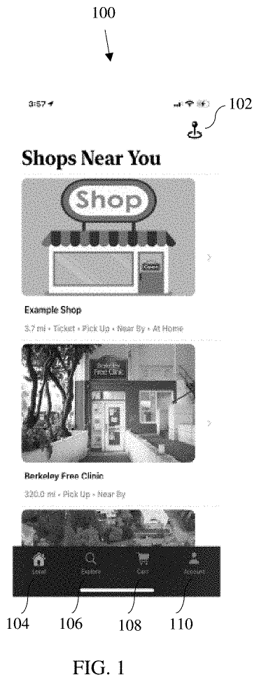

FIG. 1 is a screenshot of an illustrative user interface in a Bazar customer mobile shop for a home screen (100), in accordance with an exemplary embodiment of the present invention. Bazar customer home screen (100) is displaying a list of shops organized by proximity from a user's current location (102). The user is enabled to swipe up and down the list of shops in a vertically scrolling fashion.

The Bazar Customer application “in-use” functions as follows: Upon opening the application, a customer is presented with a menu bar on the bottom of the screen, with options to navigate to 5 different screens:
I. Stories
   A. List of Shop Stories sorted by location (Titles, Photos, Captions).
II. Explore (106)
   A. Category-based shop sorting, all shops, and customer favorited shops.
   B. View stories, categories, and favorites.
III. Local (104)
   A. List of vertically scrollable products that can be filtered by the user's proximity. Products are also sorted by frequency of impressions.
   B. List of shops sorted by a location.
IV. Cart (108)
   A. Contains products selected for purchase by customer.
   B. View products/services added to the cart.
V. Account (110)
   A. Account Details contains information regarding past orders, sign up, and login.

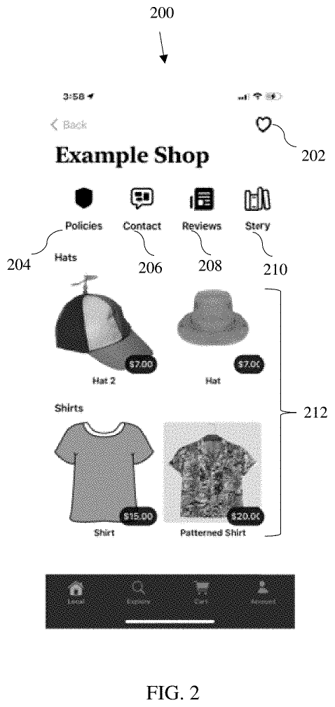

FIG. 2 illustrates an exemplary user interface for a merchant shop and product detail page (200) installed on a mobile user device, in accordance with an exemplary embodiment of the present invention. The “Local” home screen of the merchant shop contains a list of vertically scrollable products (212) that are available for purchase through the Bazar platform. Further, the “Local” home screen comprises a heart symbol (202) at the upper top right corner. The user is enabled to favorite a shop for future reference by selecting the heart symbol (202). The merchant store is saved in the explore section. The products (212) are listed using a refreshable randomizer based on features such as proximity, demand, and pricing. Each product may be clicked to shop fronts that are selectable and navigate the customer to a representation of the shop. The top-level toolbar contains selectable buttons which navigate the customer to displays of the shop's policies (204), contact information (206), reviews (208), and story (210). The shop policies (204) open a list of policies the merchant has chosen for their shop. The contact information (206) opens a view of the merchant's contact information. The shop reviews (208) show a list of reviews made by customers who have ordered products. The shop story (210) shows a list of (title, picture, caption) created by the merchant to explain their shop and mission. Beneath the toolbar is a categorized list of products/services (212), which are labeled with prices. The product toolbar contains a vertically scrolling list that demonstrates the various categories of products/services (212) offered by the merchant (i.e., Hats, Shirts). Within each of these categories is a horizontal scrolling list where the customer can view products/services (212) within that particular category.

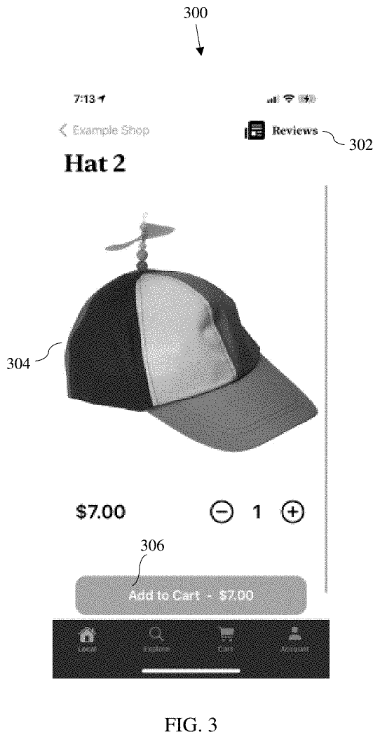

FIG. 3 is a screenshot of an illustrative user interface in a Bazar customer mobile shop for a selected product (300), in accordance with an exemplary embodiment of the present invention.

In response to user selection of the product, the Bazar customer mobile shop shows the user interface of the product detail page (300). Each product/service (304) is selectable and leads to the product/service screen. The product detail page (300) shows the product/service name (304), images, details, features, and allows customers to select a quantity of product/service to add to their cart (306). Once a product/service is added to the cart (306), it appears on the cart screen Alternatively, cart items may also be added to the cart using a scanner from a Ticket method. The product detail page (300) further comprises the review tab (302) at the upper right corner. Further, the customer is enabled to view reviews specific to the selected product/service (306).

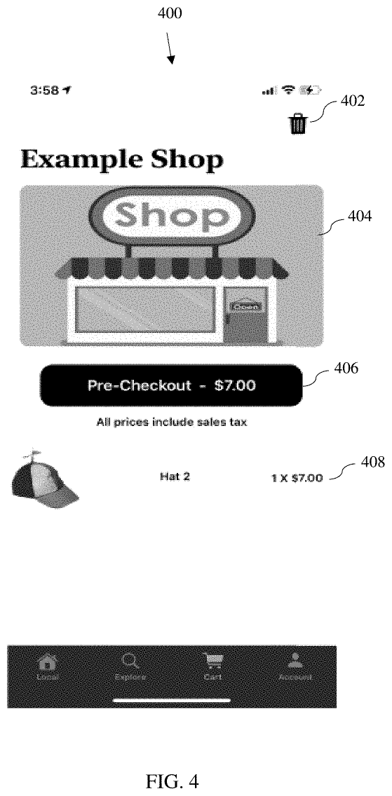

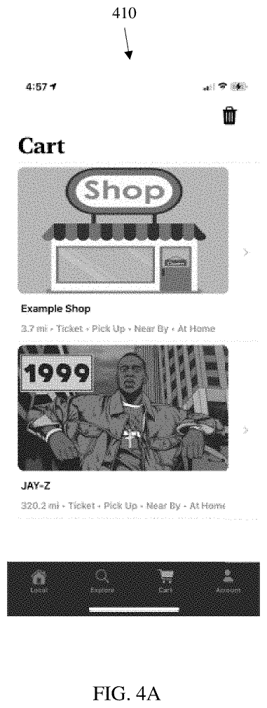

FIG. 4 and FIG. 4A illustrate an exemplary user interface for a single cart view (400) and multi-cart view (410), in accordance with an exemplary embodiment of the present invention. The single cart view (400) shows the products selected for purchase by the customer. The single cart view screen (400) shows a selectable image (404) of the shop that redirects back to the merchant shop, a pre checkout screen (406), and the product (408) added to the cart. Beneath the pre checkout screen (406), the customer may select the products (408) from their cart and optionally change the quantity, features, or remove the product/service (408) from their cart. Further, the customer is enabled to clear the product/services (408) added to the cart by clicking on the bin button (402). The multi-cart view (410) shows the shops that are proximate to the customer. The customer is enabled to view carts from the multiple shops.

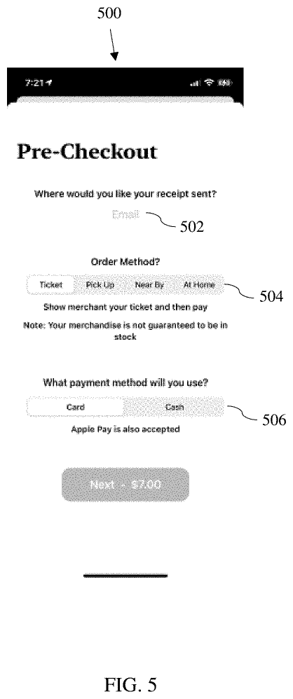

FIG. 5 is a screenshot of an illustrative user interface in a custom mobile shop for a pre-checkout page (500), in accordance with an exemplary embodiment of the present invention. When the customer is ready to checkout, they select the “pre-checkout” button, which leads to the pre-checkout page (500). The customer enters the email they want the receipt sent to and selects from the order methods (504) that the merchant has chosen to provide. The order methods (504) are Ticket, Pick Up, Near By, At Home. The customer is enabled to select between payment method. i.e., Card, or Cash.

In one exemplary embodiment, merchant-facing mobile application is depicted. The merchant-facing application enables merchants to create a custom mobile store, where they can upload, edit, and create product and service listings. Merchants may additionally customize provided order fulfillments processes. Specifically, they may provide customers with any combination of the following six ordering capabilities: Cash, Standard, Ticket, Pick Up, Near By, and At Home. Standard and Ticket orders utilize a credit card reader to fulfill payments, whereas Pick Up, Near By, and At Home orders utilize an online portal to make payments, which are subsequently fulfilled by the merchant. Merchants may add additional service charges or request tips on the Pick Up, Near By, and At Home fulfillment options. For At Home Deliveries, radius-based delivery charges may be applied in order to incentivize customers to buy products locally.

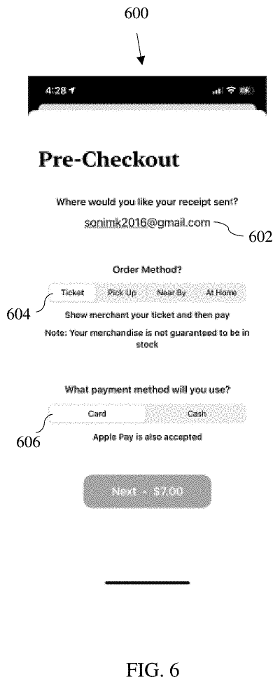

FIG. 6 is a screenshot of an illustrative user interface of a pre-checkout page with ticket method selected (600), in accordance with an exemplary embodiment of the present invention. When the customer is ready to check out, they select the “pre-checkout” button, which leads to the checkout page. The customer enters the email (602) they want the receipt sent to and selects from the order methodologies that the merchant has chosen to provide. Depending upon the selection, the customer is navigated to either: Ticket (604), Pick-Up, Near By, and At Home. The customer also selects card payment method (606). If the customer selects the Ticket Method and clicks “Next”, the screen displays a QR code representation of their cart, which the merchant may then scan. If the customer selects Pick-Up, Near By, or At Home, and then selects “Next”, it will navigate them to a screen for the customer to fill out details for the respective order method i.e., Pick Up, Near By, and At Home. These methods all end with the payment page.

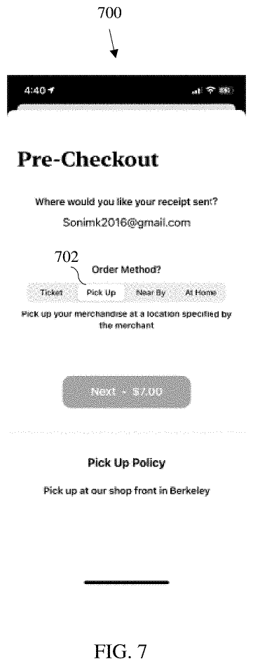

FIG. 7 is a screenshot of an illustrative user interface of a pre-checkout page with Pick Up method selected (700), in accordance with an exemplary embodiment of the present invention. The customer selects the Pick Up (702) order method.

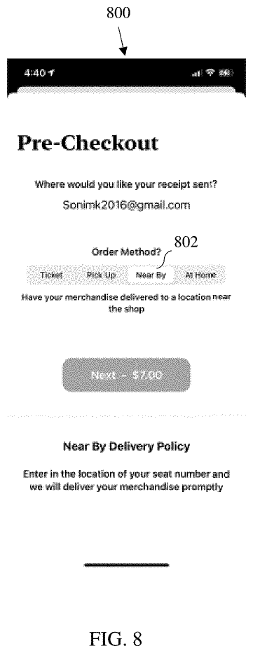

FIG. 8 is a screenshot of an illustrative user interface of a pre-checkout page with Near By method selected (800), in accordance with an exemplary embodiment of the present invention. The customer selects the Near By (802) order method.

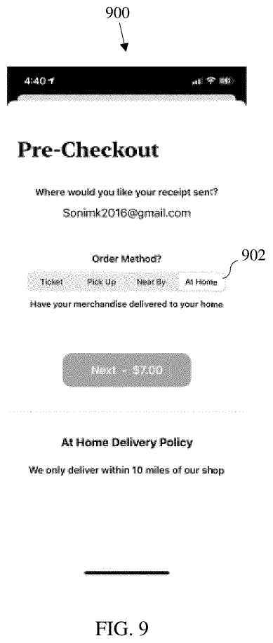

FIG. 9 is a screenshot of an illustrative user interface of a pre-checkout page with At Home method selected (900), in accordance with an exemplary embodiment of the present invention. The customer selects the At Home (902) order method. At Home Delivery policy is enabled to deliver within 10 miles of the merchant shop.

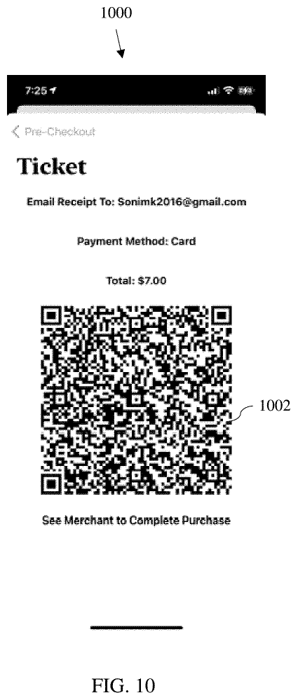

FIG. 10 is a screenshot of an illustrative user interface of a ticket method screen (1000), in accordance with an exemplary embodiment of the present invention. The ticket method screen (1000) contains a representation of the customer's cart in the QR code (1002), which is scanned by the merchant. The cart items that are either scanned in from the QR code embedded in the Ticket method using the camera scanner, or entered in by clicking products/services and adding them to the cart.

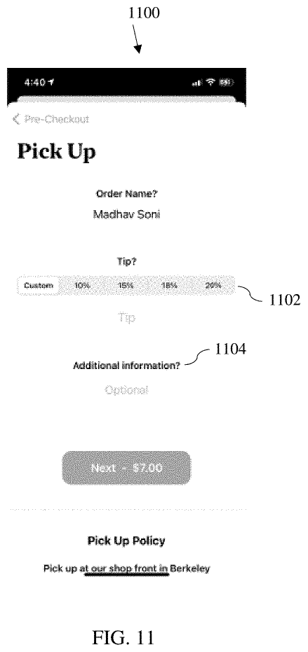

FIG. 11 is a screenshot of an illustrative user interface in a custom mobile shop for a Pick-Up Detail information screen (1100), in accordance with an exemplary embodiment of the present invention. The customer completes Pick Up additional information, if applicable (1) Displays merchant pick up policies (2) Merchant requests optional additional information (1104) from customer (3) Merchant may optionally request a tip (1102). Upon pressing Next, the customer is directed to a payment page i.e., ready to checkout.

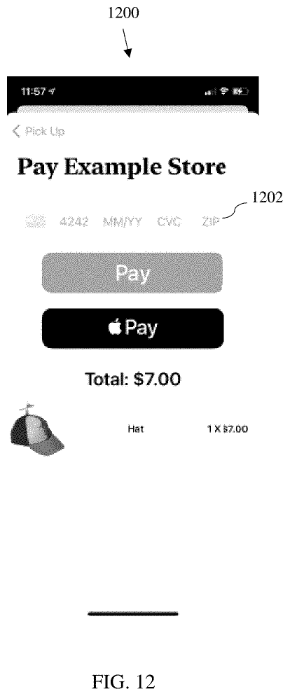

FIG. 12 illustrates an exemplary user interface for the payment page (1200), in accordance with an exemplary embodiment of the present invention. The payment page (1200) for a Pick-Up method shows the customer payment page. The customers may exclusively pay with a credit card (1202) through an online payment portal here.

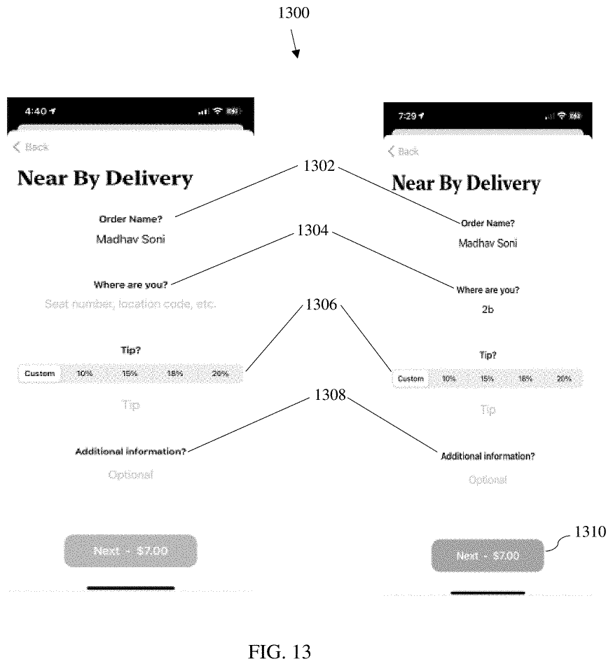

FIG. 13 are the screenshots of an illustrative user interface in a custom mobile shop for a Nearby Delivery Details Page (1300), in accordance with an exemplary embodiment of the present invention. The Nearby Delivery Details Page (1300) displays merchant Near-By Delivery policies such as order name (1302), where are you (1304) i.e., “Enter the seat number you would like your merchandise delivered to.” (1304). The customer provides delivery location information. The customer may not proceed without entering this information for example, “I am sitting in seat 2b”. Merchant may optionally request a tip (1306). Requests optional additional information from customer such as “Please include napkins with the order”. (1308). Near By Delivery Details Page (1300) with Next Button Enabled (1310) is also shown in the figure. The customer is enabled to press the Next Button (1310) to proceed to checkout.

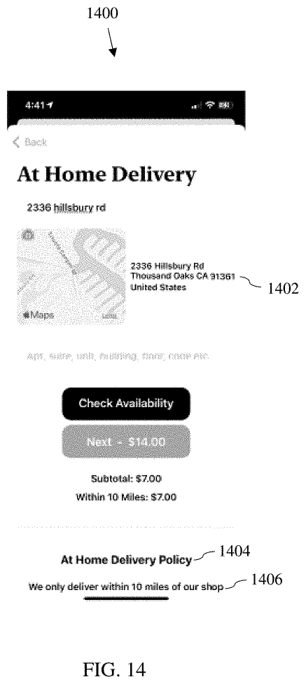

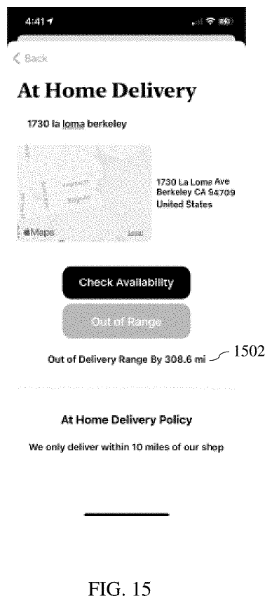

FIG. 14 and FIG. 15 are screenshots of an illustrative user interface in a custom mobile shop for a Home Delivery Details Screen (1400), in accordance with an exemplary embodiment of the present invention. The Home Delivery Details Screen (1400) displays merchant At Home Delivery policy (1404). The Home Delivery Details Screen (1400) requests At Home customer location for delivery (1402). The customer may not proceed without entering this information and must enter a valid location within radius (1406) set by merchant. If valid location, fulfillment details are requested, for example, Apartment Number, PO Box, etc. A valid location is determined by customizable delivery radius (1406) based service charges created by the merchant. An additional service charge may be applied by the merchant depending on the location of delivery. Further, the Home Delivery Details Screen (1400) requests optional additional information from customer for example, “Leave on front door”.

With reference to FIG. 15, the Home Delivery Details Screen shows the out of delivery range (1502) set by the merchant.

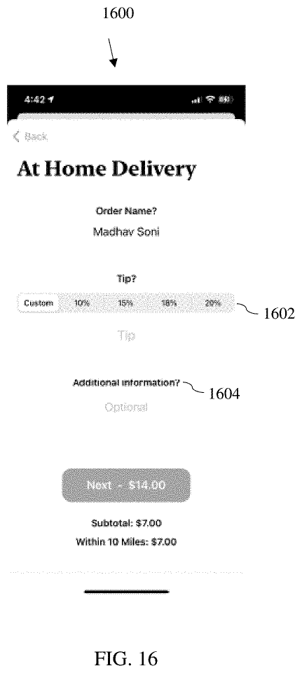

FIG. 16 is a screenshot of an illustrative user interface for a Home Delivery Details Page (1600), in accordance with an exemplary embodiment of the present invention. The merchant may optionally request a tip (1602), and additional information from customer (1604), for example, “Leave on front door”.

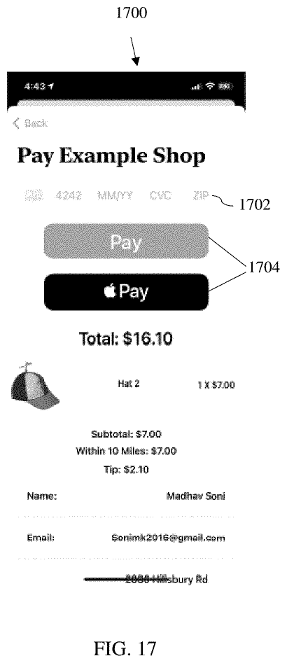

FIG. 17 is a screenshot of an illustrative user interface for At Home Payment Page (1700), in accordance with an exemplary embodiment of the present invention. The customer is presented with a screen to complete their purchase. The customer proceeds to checkout. The customer is presented with a payment page. The customers may exclusively pay (1704) with a credit card (1702) through an online payment portal here.

Upon completion of payment for Pick Up, Near By, and At Home, the customer will receive a receipt of their order. The customer may then show the displayed code to the merchant. The merchant may use a camera scanner to scan in the code and fulfill the order, which are both merchant facing screens.

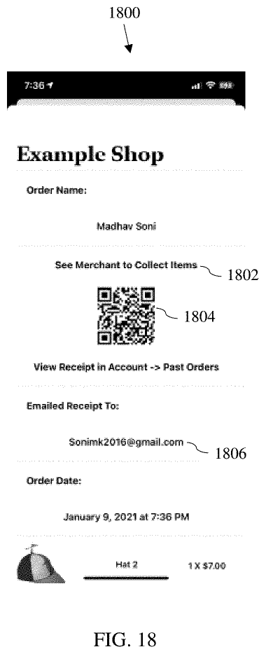

FIG. 18 is a screenshot of an illustrative user interface for a receipt (1800), in accordance with an exemplary embodiment of the present invention. The customer is presented with a receipt of their purchase upon completion. The receipt (1800) shows order name (1802), QR code (1804) representation of receipt which is scanned by the merchant for the fulfilment of the order. The receipt is also sent to email (1806). The receipt may be reviewed in the Account tab. For Pick Up, Near By, and At Home orders, Orders may also be fulfilled by scanning in a QR code representation of the customer's receipt by using the scanner, where the merchant may then fulfill an order. Upon fulfillment, the order moves from the unfulfilled orders section to the fulfilled orders section.

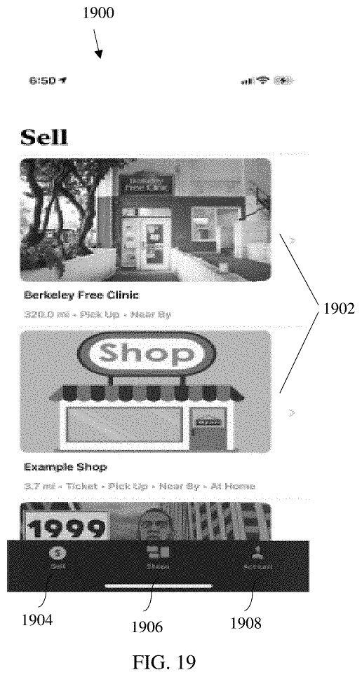

FIG. 19 illustrates an exemplary user interface for a Bazar Merchant Home Screen (1900), in accordance with an exemplary embodiment of the present invention. The Bazar Merchant Home Screen (1900) displays list of shops (1902) managed by the merchant organized by name. The list of shops (1902) may be swiped up and down in a vertically scrolling fashion. The list of shops (1902) is clickable and lead to the merchant facing display of the shop. The Bazar Merchant application “in-use” functions as follows. Upon opening the application, the merchant is presented with a menu bar on the bottom of the screen, with options to navigate to 3 different screens:
I. Sell tab (1904): List of selectable managed shops.
II. Shops tab (1906): List of managed shops by permission level
III. Account (1908): Account Details contains general account information, such as email, name, and password configurations.

Upon selecting a shop from the sell tab (1904), the merchant can view the shop sell view. The Shops tab (1906) navigates merchants to the list of shops managed by the merchant, organized by the merchant's permission access to the shop. Owners have full access to all features of a shop from the Shop Menu and sell tab (1904). Administrators have full access to all features of a shop from the Shop Menu and sell tab (1904). Administrators may not remove an owner's access to the shop. Sellers only have access to shop features on the sell tab (1904).

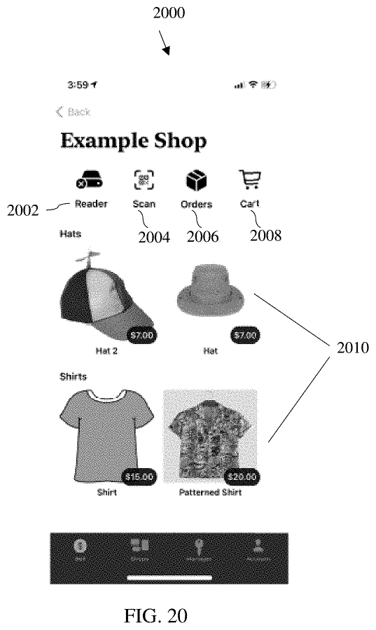

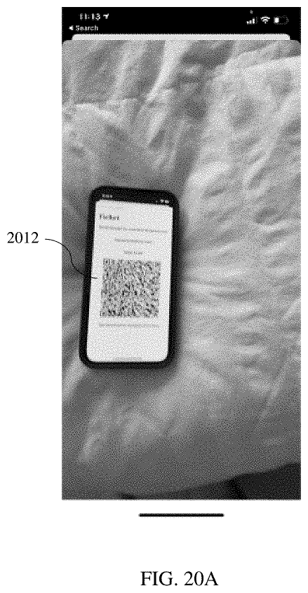

FIG. 20 illustrates an exemplary user interface for a Bazar merchant shop screen (2000), in accordance with an exemplary embodiment of the present invention. At the top of this screen (2000) is a toolbar containing selectable buttons that navigate the merchant to screens displaying the following:
I. Reader (2002)
   A. Merchant can connect to a credit card reader.
II. Scan (2004)
   A. Camera scanner used by merchant in order to scan in QR codes.
III. Orders (2006)
   A. Merchant can view past orders.
IV. Cart (2008)
   A. Contains cart items that are either scanned in from the QR code embedded in the Ticket method using the camera scanner, or entered in by clicking products/services and adding them to the cart.

The Bazar merchant shop screen (2000) shows a list of products (2010) sold by the merchant.

FIG. 20A shows a camera scanner (2012) of the merchant, in accordance with an exemplary embodiment of the present invention. The merchant may use a camera scanner (2102) to scan in the code and fulfill the order, which are both merchant facing screens.

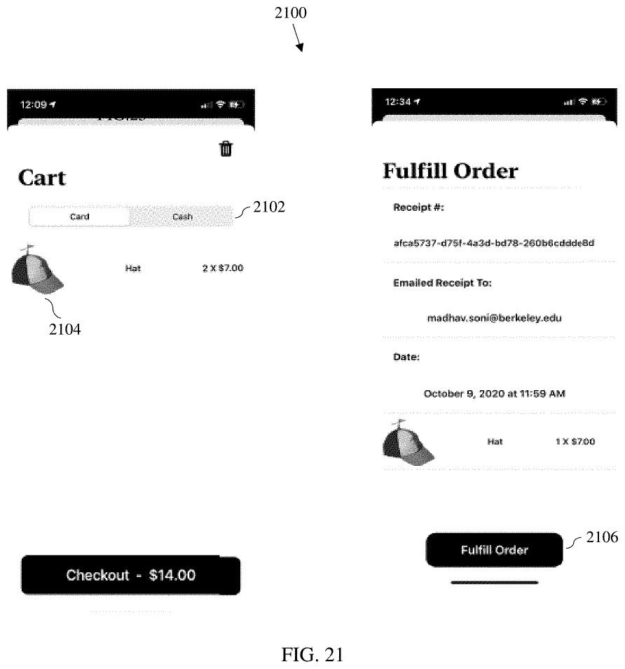

FIG. 21 illustrates an exemplary user interface for a demonstration of the merchant cart (2100), in accordance with an exemplary embodiment of the present invention. The products (2104) appears on the merchant cart (2100). The merchant can clear cart with trash can at the top.

The merchant can edit products by clicking on them. The user is enabled to pay using card or cash (2102). Checkout leads to a page where the merchant can scan in a credit card using a credit card reader and fulfill the order (2106).

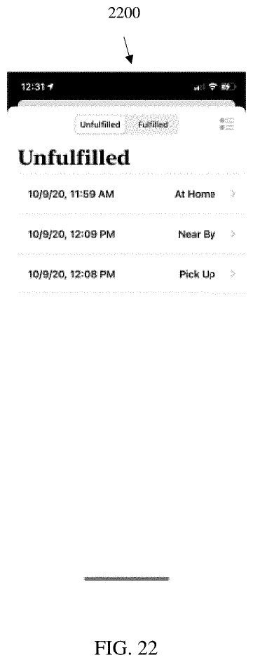

FIG. 22 is a screenshot of an unfulfilled orders (2200) for At Home, Near By, and Pick Up order methods, in accordance with an exemplary embodiment of the present invention.

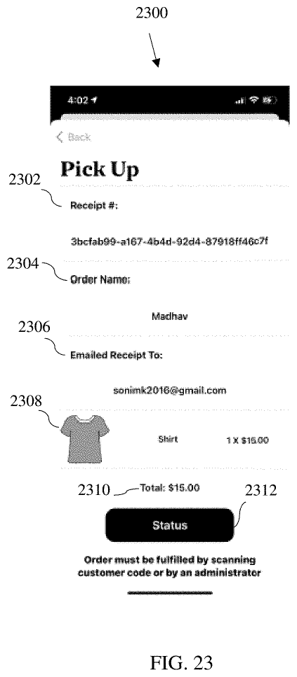

FIG. 23 is a screenshot of an illustrative user interface of receipt of an unfulfilled order (2300), in accordance with an exemplary embodiment of the present invention. The receipt of an unfulfilled order for the Pick Up method shows receipt number (2302), Order name (2304), Emailed Receipt to: (2306), Product detail (2308), total amount (2310) and the status button (2312).

The orders toolbar item contains a list of past unfulfilled and fulfilled orders for the shop. Each order leads to an order detail page. The order detail page contains order information including but not limited to the receipt number, the email of the customer, the products/services purchased, applied service charges, applied tips, the order total, fulfillment information, the date of purchase, and the date of fulfillment.

For At Home Orders, an additional “Fulfill Order” option prompts the merchant to either include a message or upload an image of the order. This action moves an order from Unfulfilled to Fulfilled.

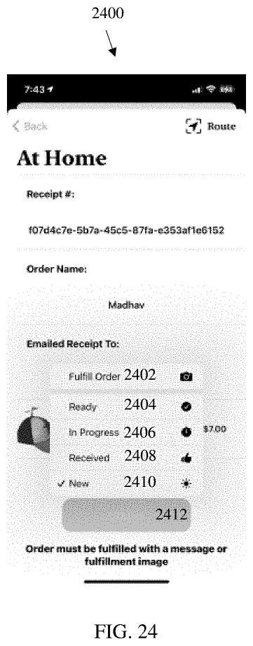

FIG. 24 is a screenshot of an illustrative user interface of Receipt of an Unfulfilled Order (2400) for the At Home method, in accordance with an exemplary embodiment of the present invention. The “Status” button (2412) enables merchants to alert other merchants in addition to the customer about the order status. Possible statuses include but are not limited to “New” (2410), “Received” (2408), “In Progress” (2406), and “Ready” (2404). For At Home orders, the “Fulfill Order” (2402) option is available which enables the merchant to upload an image of the fulfillment for at Home deliveries. This image is available to both merchants and customers.

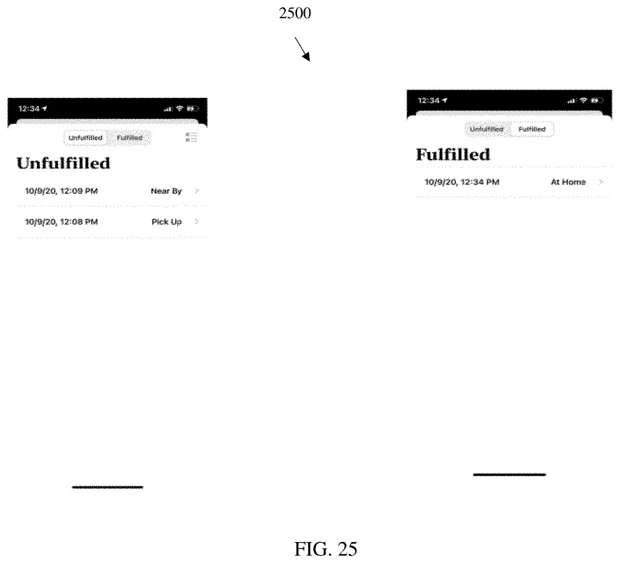

FIG. 25 are the screenshots of an illustrative user interface for the movement from an unfulfilled order to a fulfilled order (2500) in the At Home order method, in accordance with an exemplary embodiment of the present invention.

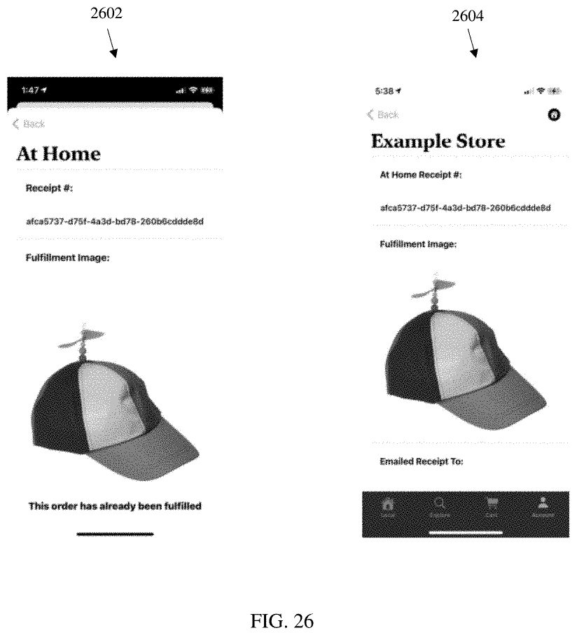

FIG. 26 are the screenshots of a fulfillment image demonstration merchant view (2602) and the customer view (2604), in accordance with an exemplary embodiment of the present invention.

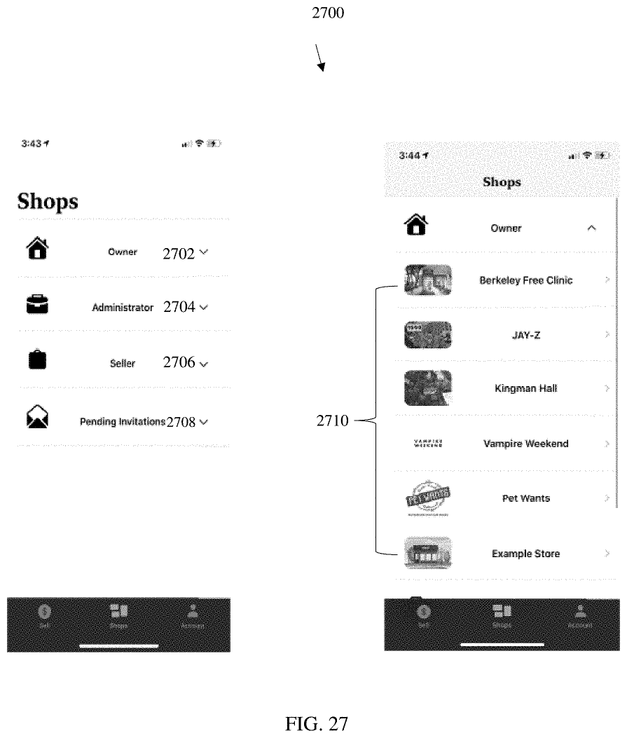

FIG. 27 are screen shots of an illustrative user interface in a custom mobile shop for list of store permissions (2700), in accordance with an exemplary embodiment of the present invention. Each permission opens to a list of managed shops (2710). The shops tab navigates merchants to a list of shops managed by the merchant, organized by the merchant's permission access to the shop, owners (2702) have full access to all features of a shop from the shop menu and sell tab. Administrators (2704) have full access to all features of a shop from the shop menu and sell tab. Administrators (2704) may not remove an owner's access to the shop. Sellers (2706) only have access to shop features on the sell tab. For owners (2702) and administrators (2704), each store link leads to the shop menu. Furthermore, the merchant may hire others to sell on behalf of their shop. As such, the merchant may enable one or more other merchants to either be administrators (2704) or sellers (2706).

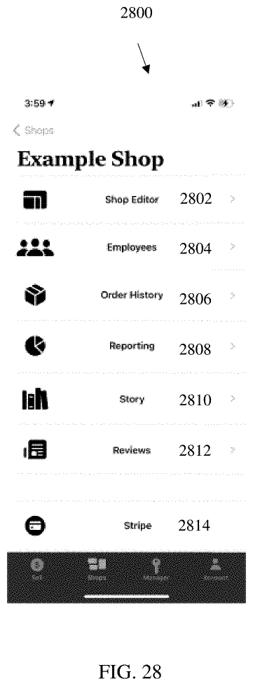

FIG. 28 illustrates an exemplary user interface of the shop menu (2800), in accordance with an exemplary embodiment of the present invention. The Shop Menu enables a merchant to access and make changes to the managed shop. These features are available exclusively to shop owners and administrators. Capabilities include:
I. Shop Editor (2802)
   A. Merchant can edit categories, products, and shop details
II. Employees (2804)
   A. Merchant may invite another merchant as either an administrator or a seller
      1. Merchants may alternatively remove other administrators and sellers, excluding the shop owner
III. Administrative Order History (2806)
   A. Displays past orders made split into Unfulfilled, Fulfilled, and Refunds
      1. Sample Unfulfilled Order
         a) Merchant may refund an order
            (1) Pressing “Refund” prompts merchant to enter a refund reason and their password to confirm the refund
         b) Force fulfillment allows fulfillment without picture or scanning code
IV. Reporting (2808)
   A. Merchants can view sales reporting information
V. Story (2810)
   A. Merchants can create, edit, and delete past Stories (Title, Photo/Video, Caption)
   B. If the shop is on display, these stories will be displayed in the public “Stories” feed.
   C. These Stories will also be on display in a customer facing shop.
VI. Reviews (2812)
   A. Merchants may view past reviews.
VII. Stripe (2814)
   A. Opens a link to the website of Bazar's payment gateway partner.

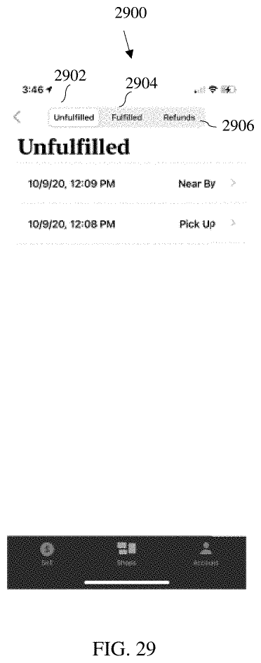

FIG. 29 illustrates an exemplary user interface for an administrative order history page (2900), in accordance with an exemplary embodiment of the present invention. The administrative order history page (2900) displays past orders made split into unfulfilled (2902), fulfilled (2904), and refunds (2906).

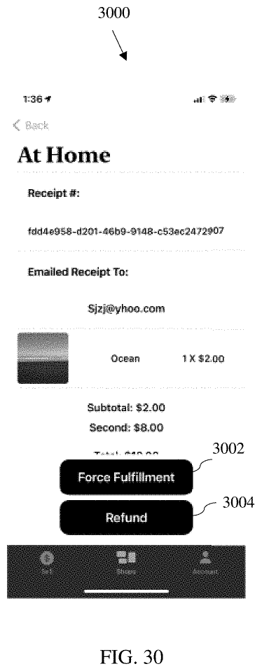

FIG. 30 is a screen shot of an illustrative user interface of sample unfulfilled order (3000), in accordance with an exemplary embodiment of the present invention. The merchant may refund an order. Pressing “Refund” (3004) prompts merchant to enter a refund reason and their password to confirm the refund and force fulfillment (3002) allows fulfillment without picture, message or scanning code.

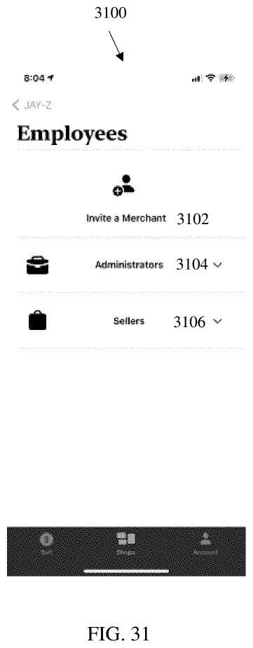

FIG. 31 is a screen shot of an illustrative user interface of custom mobile shop for invite employee of two different permission levels (3100), in accordance with an exemplary embodiment of the present invention. The merchant may invite another merchant (3102) as either an administrator (3104) or a seller (3106). Merchants may alternatively remove other administrators and sellers, excluding the shop owner. Administrators have access to all owner permissions with the exception of removing the owner from the shop.

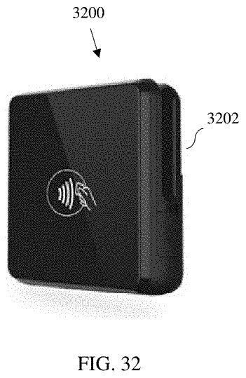

FIG. 32 illustrates a BBPOS credit card reader (3200), in accordance with an exemplary embodiment of the present invention. Merchant can connect to the BBPOS credit card reader (3200).

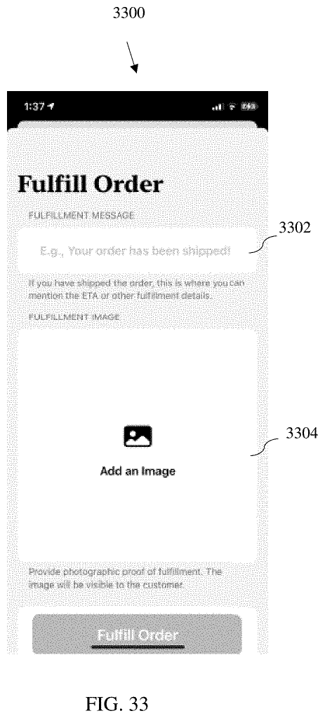

FIG. 33 illustrates an exemplary user interface At Home delivery fulfillment (3300), in accordance with an exemplary embodiment of the present invention. In At Home delivery fulfillment, the merchant approaches customer at delivery location, and scans customer QR code representation of receipt if customer is present. If customer is not present, merchant may provide customer with an image of fulfillment (3304) or a message (3302) to fulfill the order. The product is designed such that sellers may only fulfill an order if a customer is present.

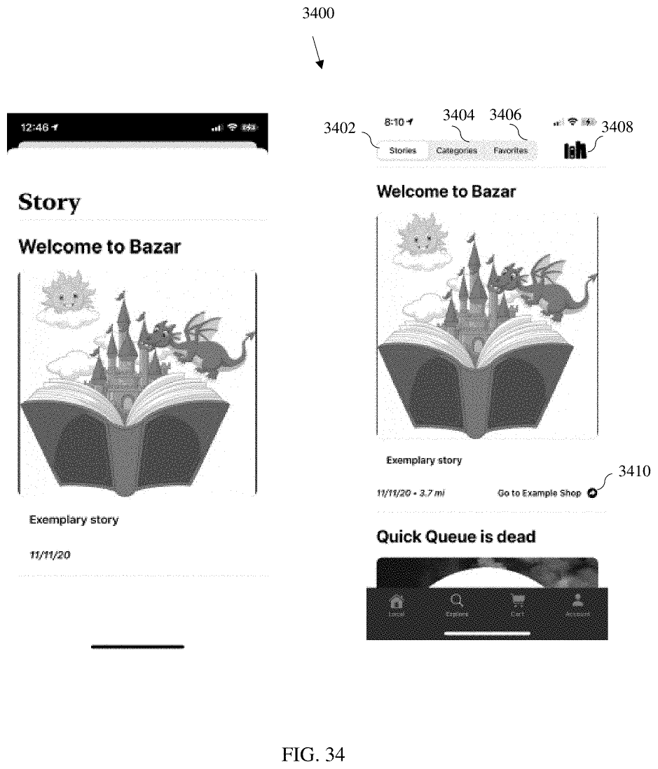

FIG. 34 is a screen shot of a shop story (3400), in accordance with an exemplary embodiment of the present invention. The explore tab shows three horizontals scrolling screens: Stories (3402), categories (3404), and favorites (3406). Further, the Go to Example Shop button (3410) directs customer to the shop, and a selectable button (3408) opens up a menu bar enabling the customer to choose radius of stories to view.

In order to better connect with their customers, merchants may also post to their story, where they can post a photo/video, a caption, and a title with a description of what they are up to. Upon posting this story, customers may either view the story (3402) through the shop. They may alternatively view the story (3402) in the public story feed. This feature is meant to create a humanist environment to the application in addition to providing merchants with a feed to advertise themselves through. Customers will also have the ability to comment and s with posts to establish better merchant-customer relationships.

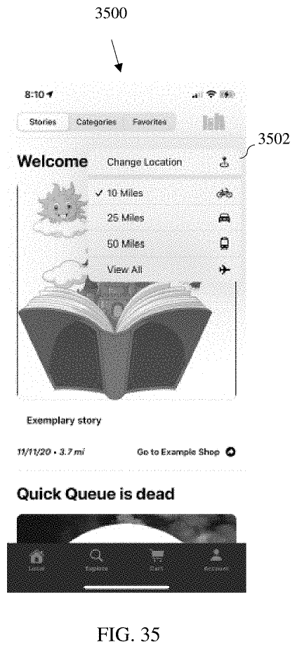

FIG. 35 is a screen shot of an illustrative user interface for the explore tab (3500), in accordance with an exemplary embodiment of the present invention. The customer is enabled to change location (3502) i.e., 10 Miles, 25 Miles, 50 Miles to view different shop stories in that radius. The various distance selections determine which stories to display to the customer. Public Story Feed—List of vertical scrolling stories from shops within a radius (3502) selected by the customer.

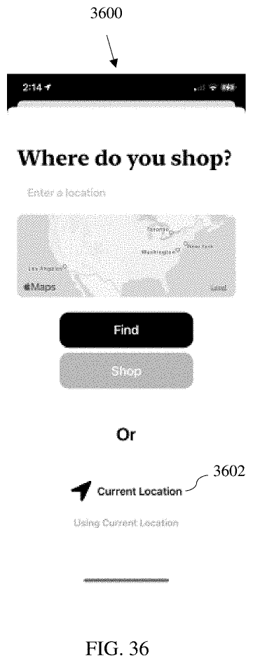

FIG. 36 is a screen shot of an illustrative user to enter current location (3600), in accordance with an exemplary embodiment of the present invention. Customer may enter a location of where they would like to shop, or alternatively use their current location (3602).

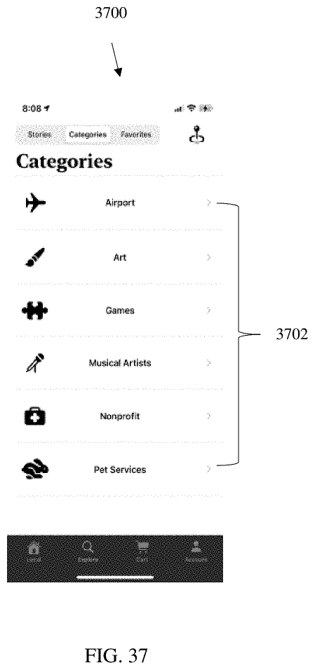

FIG. 37 is a screen shot of an illustrative user interface for categories (3700), in accordance with an exemplary embodiment of the present invention. A list of categories (3702) is provided from which the customer may shop from. The list of category names and associated symbols (3702) are shown. Clicking a particular category leads the customer to a view of shops ordered by the location associated with the category.

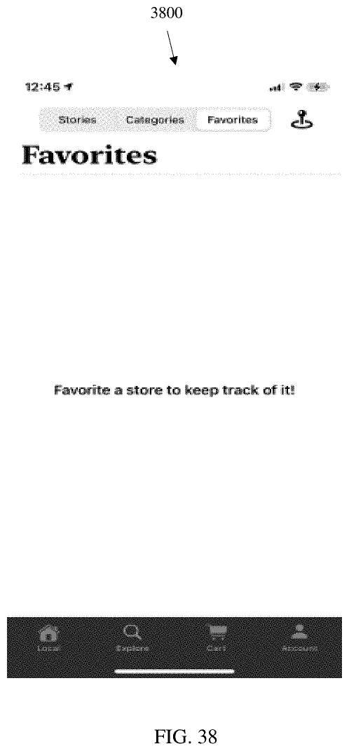

FIG. 38 is a screen shot of an illustrative user interface for customers to view favorited shops (3800), in accordance with an exemplary embodiment of the present invention. The favorites tab allow customer to view shops they have favorited.

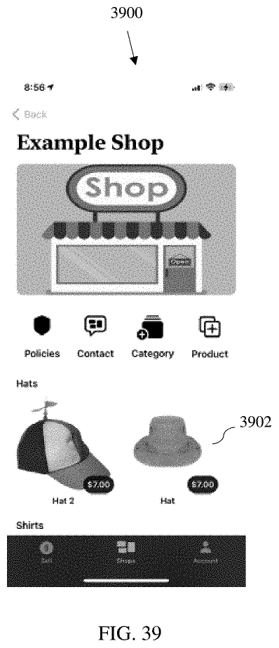

FIG. 39 is a screen shot of a shop editor (3900), in accordance with an exemplary embodiment of the present invention. The merchant can edit categories, products (3902), and shop details.

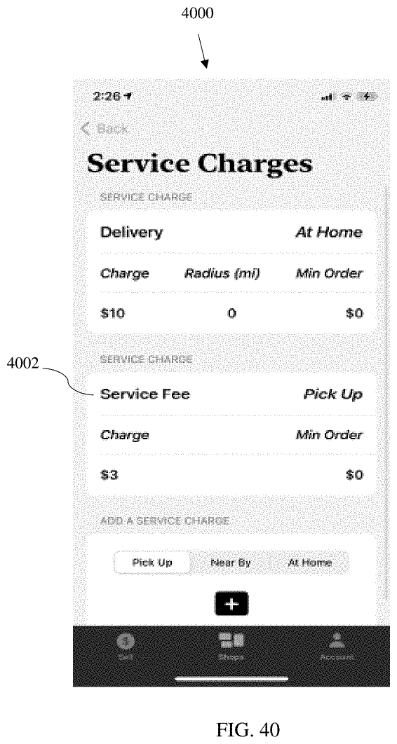

FIG. 40 is a screen shot of service charges (4000), in accordance with an exemplary embodiment of the present invention. The merchants may add optional service charges (4002), such as shipping and tax charges based on order method i.e., Pick Up in the figure. At Home service charges may optionally include a delivery radius to incentive local shopping. This screen is found within the “Policies” page.

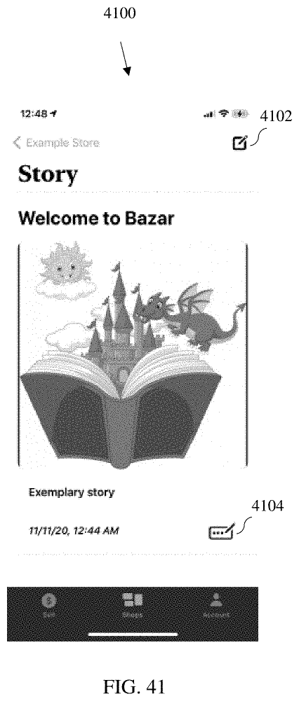

FIG. 41 is a screen shot of an illustrative user interface for story creation and editing page (4100), in accordance with an exemplary embodiment of the present invention. The merchants can create, edit, and delete past Stories (Title, Photo, Caption). The merchant navigates to story creation page by clicking on a first button (4102). The merchant navigates to story editing page by clicking on a second button (4104).

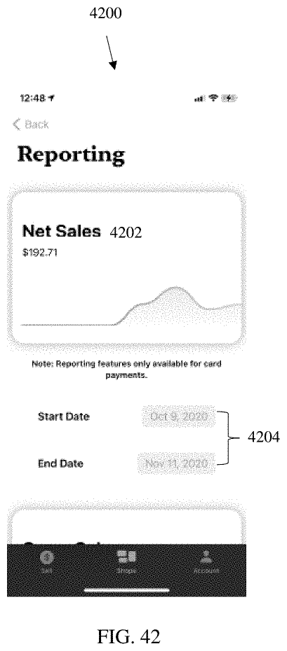

FIG. 42 illustrates an exemplary user interface for Merchant Shop Reporting (4200), in accordance with an exemplary embodiment of the present invention. The merchants can view sales reporting information i.e., net sales (4202) by entering the start date and end date (4204).

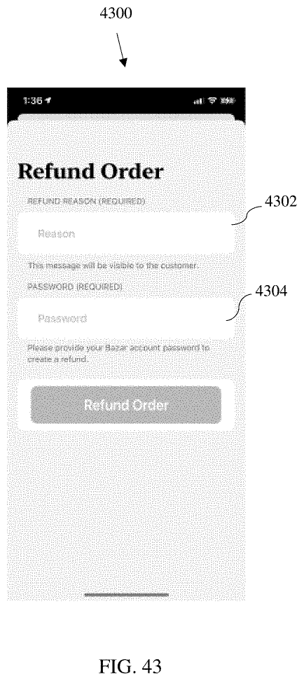

FIG. 43 illustrates an exemplary user interface for Refund Order (4300), in accordance with an exemplary embodiment of the present invention. The merchant may refund an order. The merchant is enabled to enter a refund reason (4302) and their password (4304) to confirm the refund.

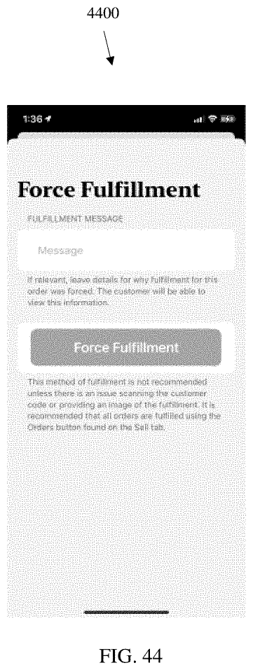

FIG. 44 illustrates an exemplary user interface for force fulfillment (4400), in accordance with an exemplary embodiment of the present invention. Shop owner and administrators may force fulfillment.

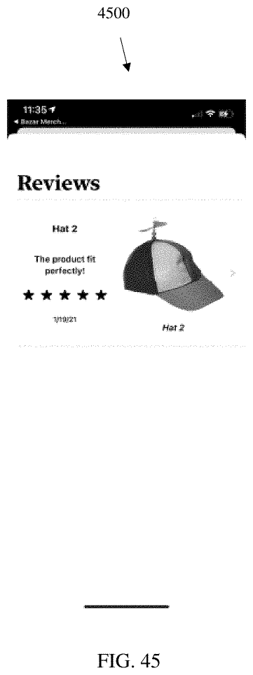

FIG. 45 is a screenshot for a review page (4500), in accordance with an exemplary embodiment of the present invention. The review page (4500) shows the reviews gives for the product by other customers.

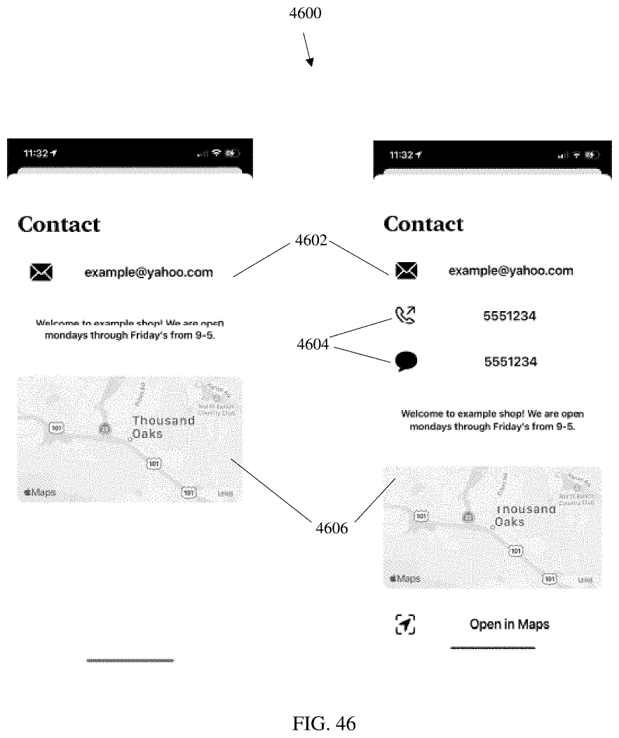

FIG. 46 are screenshots for an exemplary contact page without and with the optional fields (4600), in accordance with an exemplary embodiment of the present invention. The customers may also view the contact information of the merchant. It should be noted that the merchant may optionally provide particular fields such as their email (4602), phone number (4604), text number, and whether the customer may locate the merchant's shop (4606). This is intentionally designed such that merchants using a residential location, or do not have access to a business phone, do not need to provide such information. Thus, Bazar becomes accessible not only to established businesses with a physical storefront, but also businesses run from a home. The contact button is also to contain a messaging system between logged in users for secure communications regarding order status, price adjustments, and other points of engagement.

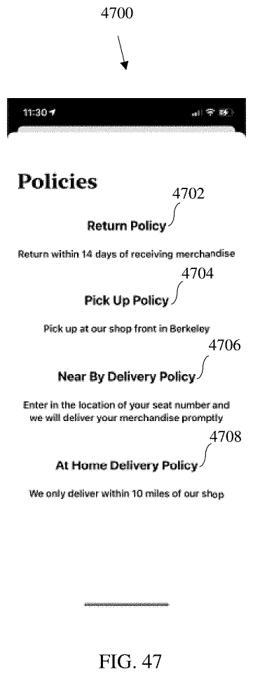

FIG. 47 illustrates an exemplary user interface for an exemplary policies page (4700), in accordance with an exemplary embodiment of the present invention. The exemplary policies page (4700) shows return policy (4702), Pick Up policy (4704), Near By delivery policy (4706), and At Home delivery policy (4708). The policies present depend upon the order methodologies offered by the merchant.

In one exemplary embodiment, each order methodology is subdivided into three distinct temporal categories: Order Selection, Checkout, and Fulfillment. Order Selection is the process of selecting products/services and entering relevant details required for fulfillment, including but not limited to email, delivery address, additional information, and a tip. Checkout involves entering and processing payment information, whether it be through a credit card reader or an online payment portal. Fulfillment involves the merchant fulfilling the order by providing the products/services to the customer. For Cash, Standard, and Ticket orders, checkout and fulfillment happen concurrently.
I. Order Methodologies
   A. Cash
      1. Prerequisite
         a) No customer-facing application is necessary. Merchant-facing application is necessary.
      2. Order Selection
         a) Merchant selects products
         b) Merchant goes to Cart
         c) Merchant asks customer for option of email receipt
         d) Merchant enters in customer email
      3. Checkout and Fulfillment
         a) Merchant receives customer cash payment and provides customer with product or service
         b) Receipt is sent to the customer's email
B. Standard
   1. Prerequisite
      a) No customer-facing application is necessary. Merchant-facing application is necessary.
   2. Order Selection
      a) Merchant selects products
      b) Merchant goes to Cart
      c) Merchant asks customer for option of email receipt
      d) Merchant enters in customer email
   3. Checkout and Fulfillment
      a) Merchant receives customer payment using reader and provides customer with product or service
      b) Receipt is sent to the customer's email

The Standard order methodology advantageously avoids the more expensive online portal charges/costs. The Standard methodology also serves as a standalone Point-of-Sale system. In situations where the customer does not have access to the Bazar customer app, the merchant may still accept payments from the customer.

C. Ticket
1. Prerequisite
   a) Both merchant and customer applications are necessary
2. Order Selection
   a) Customer selects products from the merchant store on the app
   b) Customer completes Checkout
      (1) Fill in email
         (a) If logged in, the email is auto-filled
      (2) Select the Payment Method that will be used when customer approaches Merchant
         (a) Cash or credit card is accepted
   c) Customer Proceeds to Ticket Page displaying QR code
3. Checkout and Fulfillment
   a) Customer approaches Merchant with a QR code of cart on the Ticket page
   b) Merchant Scans QR code displayed on Ticket Page
   c) Products appear in Merchant Cart
   d) Merchant proceeds to fulfill order
   e) Merchant receives customer payment using reader and provides customer with product or service
      (1) Cash or credit card is accepted
   f) Receipt is automatically sent to the customer's email

The Ticket method advantageously benefits from aspects of the Standard method, in that the merchant may make any necessary adjustments to the customer's order should the scanned in order require any changes. The Ticket methodology is further described in greater detail below.
D. Pick-Up
   1. Prerequisite
      a) Both merchant and customer applications are necessary
   2. Order Selection
      a) Customer selects products
      b) Customer completes Checkout
         (1) Fill in email
         (a) If logged in, the email is auto-filled
      c) Customer completes Pick Up Additional Information, if applicable
         (1) Displays merchant pick up policies
         (2) Merchant requests optional additional information from customer
         (3) Merchant may optionally request a tip
   3. Payment
      a) Proceed to Payment
         (1) Customer payment page
         (2) Customers may exclusively pay with a credit card through an online payment portal here
      b) Receipt shown with QR code representation of receipt
         (1) Receipt also sent to email
   4. Fulfillment
      a) Customer presents Merchant with QR code representation of receipt
      b) Merchant scans code
      c) Merchant fulfills order
E. Near By
   1. Prerequisite
      a) Both merchant and customer applications are necessary
   2. Order Selection
      a) Customer selects products
      b) Customer completes Checkout
         (1) Fill in email
         (a) If logged in, the email is auto-filled
      c) Customer completes Near By Delivery Details
         (1) Displays merchant Near By Delivery policies such as “Enter the seat number you would like your merchandise delivered to.”
         (2) Customer provides delivery location information
         (a) Customer may not proceed without entering this information
         (b) For example, “I am sitting in seat 2b”
         (3) Requests optional additional information from customer such as “Please include napkins with the order”
         (4) Merchant may optionally request a tip
3. Payment
   a) Proceed to Payment
      (1) Customer payment page
      (2) Customers may exclusively pay with a credit card through an online payment portal here
   b) Receipt shown with QR code representation of receipt
      (1) Receipt also sent to email
4. Fulfillment
   a) Merchant approaches customer at fulfillment location
   b) Merchant scans customer code
   c) Merchant fulfills order
F. At Home
   1. Prerequisite
      a) Both merchant and customer applications necessary
   2. Order Selection
      a) Customer selects products
      b) Customer completes Checkout
         (1) Fill in email
         (a) If logged in, the email is auto-filled
      c) Customer completes At Home Details
         (1) Displays merchant At Home Delivery policies
         (2) Requests At Home customer location for delivery
         (a) Customer may not proceed without entering this information
         (b) Must enter a valid location within radius set by merchant
         (3) If valid location, fulfillment details are requested
         (a) For example, Apartment Number, PO Box, etc.
         (4) Requests optional additional information from customer
         (a) For example, “Leave on front door”
         (5) Merchant may optionally request a tip
   3. Payment
      a) Proceed to Payment
         (1) Customer payment page
         (2) Customers may exclusively pay with a credit card through an online payment portal here
      b) Receipt shown with QR code representation of receipt
         (1) Receipt also sent to email
   4. Fulfillment
      a) Merchant approaches customer at delivery location
      b) Merchant scans customer QR code representation of receipt if customer is present
         (1) If customer is not present, merchant may provide customer with an image of fulfillment or a message
      c) Merchant fulfills order

On an individual product listing, merchants will also have the ability to provide the ability for their customers to “Bargain with Bazar”. If enabled on a product by the merchant, customers may request a desired price on a product in a message with a merchant. The merchant may then determine whether to accept the offer, decline the offer, or provide a counter offer.

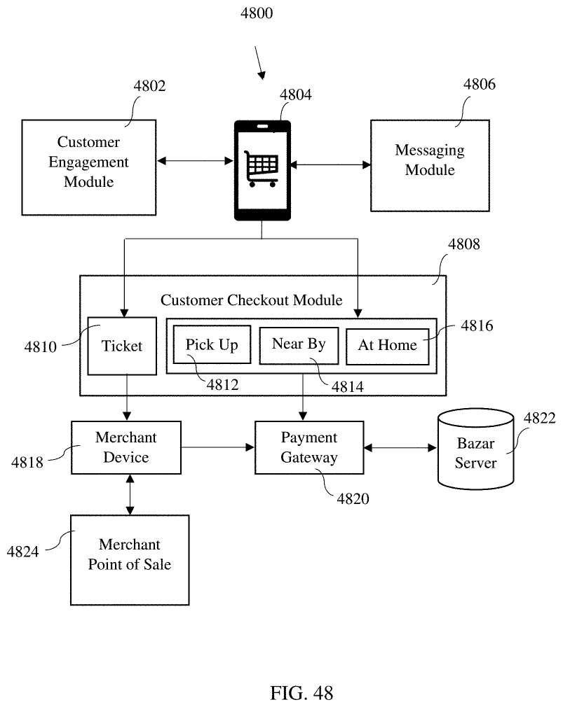

FIG. 48 is a block diagram of a mobile sales system (4800), in accordance with an exemplary embodiment of the present invention. The mobile sales system (4800) comprises of a customer engagement module (4802), a user device (4804), a messaging module (4806), a customer checkout module (4808), a merchant device (4818), a payment gateway (4820), a bazar server (4822), and a merchant point of sale (4824). In the customer engagement module (4802), the customers are enables to engage with merchant content, such as photos, videos, and captions by liking or commenting on content. In the customer engagement module (4802), customers are also enables to engage with social features in the application, such as Merchant Stories, Videos, and content to increase engagement and likelihood to purchase products or services.

The user device (4804) enables the customer to search for products on the basis of product category, locality, product tags, created date, popularity (impressions, clicks, and number of times purchased), or through a randomly generated list of products. The customers are enabled to search products from the merchant site with one and/or more store details such as store ID, Store Name, Store Image, Shop Link, Accepts Ticket, Accepts Pick Up, Accepts Near By, Accepts At Home, Return Policy, Pick Up Policy, Near By Policy, At Home Policy, Accepts Tips, Contact Information, Location (Longitude, Latitude), Is On Display, Service Charges.

In order to better connect with their customers, merchants may also post to their Story, where they can post a photo/video, a caption, and a title with a description of what they are up to. Upon posting this story, customers may either view the story through the shop with one and/or more story details such as Story ID, Store ID Attachment, Title, Content (Image, Video), Caption, Likes (Engagement Mechanism). They may alternatively view the story in the public story feed.

The customers have ability to comment and engage with posts to establish better merchant-customer relationships. The comments of users are enabled to view by the merchants with one and/or more comment details such as Comment ID, User ID, Comment and Like Count.

The customers are enabled to search products from the merchant site with one and/or more product details such as product ID, Category Type, Tags, Image, Store ID Attachment, Price, In Stock, Is Fixed Price, Description, View Count, Impressions. The customers also have the ability to view the product features (i.e., size and color) while customers are searching for products from merchant site.

In the messaging module (4806), customers may initiate conversations with shops, and merchants may engage and respond to customer questions, past orders, complaints, and custom orders. Layered onto this system is the ability for customers to inquire directly into product and order specific questions, tying in the product or order specifications into the conversation. Layered atop of this messaging system is the ability for customers to “Bargain with Bazar”. Customers may request a particular price on a product they would like, if and only if the product is not marked as a Fixed Price. Merchants may choose to accept, deny, or counter the request. If the order is accepted, the customer may proceed to checkout at the listed price.

The customer checkout module (4808) involves entering and processing payment information, whether it be through a credit card reader or an online payment portal. Specifically, merchants may provide customers with any combination of checkout such as Ticket (4810), Pick Up (4812), Near By (4814), and At Home (4816) after selecting products for purchase. If customer selects the ticket option (4810) for checkout of products, the local machine on which the application is run creates a representation of the cart in the form of a QR code.

The representation of cart in the form of QR code is obtained by converting the cart object into a string data type, which in turn is converted into a QR code using an open-source algorithm. The merchant scans in the code and accepts payment by accepting a credit card using the point of sale (4824) and making a network call to a payment gateway (4820). After accepting payment, the record of transactions is stored in the Bazar server (4822).

In the Pick Up (4812), Near By (4814), At Home (4816) method: At checkout, a record of the transaction is stored in the Bazar Server (4822). Upon completion of a successful payment to a payment gateway server (4820), the payment gateway (4820) communicates with the bazar server (4822) of the validity of the payment. The customers are then provided with a QR code with which they can validate the status of their order with the merchant.

Ticket orders (4810) utilize a credit card reader to fulfill payments, whereas Pick Up (4812), Near By (4814), and At Home orders (4816) utilize an online portal to make payments, which are subsequently fulfilled by the merchant.

Checkout involves entering and processing payment information, whether it be through a credit card reader or an online payment portal.

The present invention (“Bazar™”, “the Bazar™ App”, “the App”, “the application”) is combining a mobile Point-of-Sale and marketplace that enables merchants to accept payments and connect to their customers through a pair of mobile applications, a merchant-facing application and a customer-facing application. The present invention provides a mobile sales system, comprising a user device, a merchant server, an image acquisition device operatively connected to a point-of-sale device. The user device is configured to receive a user input including item selection with a merchant and obtain the user payment information. The user device is also enabled to generate a purchase transaction request including user payment information and provide the purchase transaction request to the merchant server. The user device having ability to obtain an electronic purchase receipt and also generate a payment code image including information from the electronic purchase receipt. Further, the user device is configured to display the payment code image, via a display operatively connected to the user device.

The image acquisition device is configured to acquire an image of the payment code image and extract data from the payment code image at the point-of-sale device. The image acquisition device is also configured to confirm the information from the electronic purchase receipt by the point-of-sale device to complete the purchase transaction.

In one exemplary embodiment, the user device is a mobile device. The user input is a touchscreen gesture on a touchscreen operatively connected to the user device.

In another exemplary embodiment, the payment code is at least a one or more one-dimensional barcode, a two-dimensional barcode and a Quick Response code.

In another exemplary embodiment, the merchant is an online marketplace merchant. The electronic purchase receipt includes a merchant identifier and a session identifier for a user shopping session with a merchant associated with the merchant identifier.

In another exemplary embodiment, the user payment information is associated with a virtual wallet account. The point-of-sale terminal is located at a physical merchant store.

In one exemplary embodiment, the present invention provides a computer-implemented mobile sales method, comprising obtaining at a user device, a user checkout request. The computer-implemented mobile sales method is configured for obtaining a user shopping cart information with a merchant related to the user checkout request, and generating via the user device, a payment code image containing information including the user shopping cart information encoded in the payment code image. The computer-implemented mobile sales method is configured for displaying the payment code image, via a display operatively connected to user device, acquiring, by the point-of-sale device, via an image acquisition device operatively connected to the point-of-sale device, an image of the payment code image, transforming the image into data encoded in the payment code image. The computer-implemented mobile sales method is configured for obtaining at the point-of-sale device, user payment information, after the step of acquiring, generating, via the point-of-sale device, a purchase transaction request including the data and providing the purchase transaction request to a server by the point-of-sale device. Further the computer-implemented mobile sales method is configured for obtaining by the point-of-sale device, a notification of authorization of the purchase transaction and obtaining an electronic purchase receipt for the purchase transaction.

In another exemplary embodiment, the shopping cart information includes account information.

In another exemplary embodiment, the step of obtaining, at the point-of-sale device, user payment information includes obtaining user payment information from the data.

In another exemplary embodiment, the step of displaying the payment code image includes obtaining, at the user device, a user input is to display the payment code image wherein the user input is a touchscreen gesture on a touchscreen is operatively connected to the user device.

In yet another exemplary embodiment, the notification of authorization of the purchase transaction is included an identifier the user shopping cart information.

In yet another exemplary embodiment, the notification of authorization of the purchase transaction is further comprises a session identifier that includes a token parameter in a uniform resource locator for the user shopping cart information.

In another exemplary embodiment, the notification of authorization of the purchase payment information is associated with a virtual wallet account.

In yet another exemplary embodiment, the present invention provides a mobile sales system comprising a merchant serve, an image acquisition device operatively connected to a point-of-sale device, and a user device configured to receive a user request to search for a product with a merchant. The mobile sales system further comprises a customer engagement module configured to receive a user request to view a product parameter associated with the merchant, and a messaging module configured to provide a communication channel between a user and the merchant to exchange messages associated with the product. The user device is configured to receive a user input including a product selection with the merchant, obtain user payment information, generate a purchase transaction request including user payment information, provide the purchase transaction request to the merchant server, obtain an electronic purchase receipt, generate a payment code image including information from the electronic purchase receipt and display the payment code image, via a display operatively connected to the user device. The image acquisition device is configured to acquire an image of the payment code image, extract data from the payment code image at the point-of-sale device and confirm the information from the electronic purchase receipt by the point-of-sale device to complete the purchase transaction.

The user device is configured to receive a user checkout request, obtain user shopping cart information with the merchant related to the user checkout request, generate a payment code image containing information including the user shopping cart information encoded in the payment code image, and display the payment code image, via the display operatively connected to the user device. The point-of-sale device is configured to acquire an image of the payment code image via the image acquisition device operatively connected to the point-of-sale device, transform the image into data encoded in the payment code image, obtain the user payment information, generate a purchase transaction request including the data, and provide the purchase transaction request to the merchant server. Further, the point-of-sale device is configured to obtain a notification of authorization of the purchase transaction and obtain an electronic purchase receipt for the purchase transaction.

In one exemplary embodiment, the user is enabled to search for the product based on the product category, product tags, product popularity, and product features. The product parameter is at least one of a product image, product video, product information, product stories, product price, likes, dislikes and comments on the product.

In one exemplary embodiment, the customer engagement module enables the user to like, dislike and/or comment on the viewed product. The messaging module is configured to provide the communication channel between the user and the merchant to exchange messages associated with the product price, user's past orders, complaints, questions related to the product, or any other product related query.

Detailed Technical Description of the Ticket Methodology

To record successful payments, an order object is generated each time an order is placed. The software records order datasets in databases located on the server. These order datasets include information about the order including but not limited to the following:
The store the product was sold at (Store)
Who the product was sold to (Customer)
The email the order's receipt was sent to (Customer email)
The Merchant who sold or fulfilled the order (Merchant)
The physical location, including coordinates, of a delivery address (Delivery location)
The status of the order (Order status)
Whether the order has been fulfilled (Completion)
The type of order (In Person, Ticket, Pick-Up, Near By, At Home) (Order type)
Fulfillment Details (i.e., apt number, seat number)
Additional Information (i.e., extra napkins etc.)
Fulfillment image of At Home delivery orders
Service Charges
Tip
Refunded by merchant (if applicable)
The identifying numbers associating the order to a successful payment
The date of the order
The last time the order was modified
The actual products sold
The cost of the products
The names of the products
The features of the products (i.e., Size, Color, etc.)
The modifiers of those features (i.e., Small, Green, etc.)
The additional cost of those modifiers

A cart object is defined as a subset of information contained in the order object. The cart object is encoded in a transmittable, abstract representation, which is then presented to the merchant. The present application utilizes a QR code, or a Quick-Response code because of its ability to represent and transmit moderate quantities of data. The application is not limited by the QR code, as any transmittable, abstract representation of data, such as a barcode, is also usable. The information contained in a cart object includes a subset of the order object information necessary for the merchant to complete the order on site, locally. An example of cart object information includes the following:
Store product is sold at
Email receipt
User ID, if the user is logged in
Cart Items
Name
Price
Quantity
Features (i.e., Size or Color)
Modifiers (i.e., Small or Blue)

The cart object is much smaller than the order dataset object and can fit into the QR code data type, which has limited space for it to work effectively. Once this object is converted to the QR code datatype, the merchant can then scan it using a scanner (FIG. 25). Additionally, this entire process does not require customers to be connected to the Internet if they already have their products in their cart as this entire process occurs locally on the customer and merchant's phones. (For payments, and getting shop information, the Internet is required).

The above Ticket process is not limited by the locally created abstract representation of a cart. The Ticket process may also include the creation of an unfulfilled order object in the backend server, which is then used to represent the order. This disadvantageously does not allow the merchant to easily edit the order on their display without creating or updating a new order object in the backend. Thus, while this process of the Ticket methodology is also possible, it is not preferable to the local creation of a smaller dataset abstraction of the order, which may easily be edited and transmitted between devices.

Payments made through an online portal are more costly than payments made through in person credit card readers. The standard rate for a payment made through an online portal is 2.9%+30¢ per order, whereas the standard rate for a payment made through a credit card reader is 2.7%+5¢. The tickets method in particular leverages less costly credit card payment methodology while simultaneously providing value created by pre-processing the product selection and receipt delivery processes. Additionally, rather than create an entire representation of an order on the server, the software creates a local representation of an abstraction of a non-recorded order. A non-recorded order is defined as an order that is recorded on local device storage, as opposed to making a network call and recording a server-side representation of the order. Thus, the consumer using the device, advantageously, is not required to connect to the internet to create the visual representation of the order

Value is thus created by minimizing resource usage of a highly scalable and frequently used process. Using the standard payment processing rates above, a concrete value of 0.2%+25 g per order is saved while simultaneously providing an indeterminate saving of time.

This was intentionally designed to increase the success rate of fulfilled orders. In this situation, success rate is defined as: the number of orders marked as and successfully fulfilled to the customer and merchant's satisfaction Divided By the number of orders marked as fulfilled.

Traditionally, Point of Sale systems only require merchants to mark an order as fulfilled by pressing a fulfill button. However, here, the merchant is required to be in physical proximity to the customer to scan the QR code (for Ticket, Pick-Up, and Near By) or provide an image or message to fulfill an order (for At Home orders). The invention advantageously increases the likelihood of successful fulfillment by requiring merchant and consumer to be in physical proximity to one another to use the QR code validation mechanism (for Ticket, Pick Up, and Near By orders), where successful fulfillment is defined as the consumer receiving the desired product and the merchant receiving the agreed upon payment. This invention is particularly advantageous in situations where products being sold are limited or in high demand, or there is increased consumer congestion. When merchants can confirm the valid exchange of product, there is higher likelihood that products will not be stolen or misplaced. Thus, the success rate as defined above would naturally increase given the necessitation for merchants and customers to be in physical proximity to one another to validate the exchange of goods.

Customers may additionally respond to their orders by providing reviews on products they have purchased, which was implemented in order to build customer trust with the Bazar platform. See top toolbar.

A point-of-sale system is provided. The system includes a customer-facing application resident on a customer device and a merchant-facing application resident on a merchant device wherein the customer-facing application converts cart information into a code scannable by the merchant device to fulfill the order.

A method for increasing point of sale fulfillment accuracy is provided. The method includes the step of a customer presenting to the merchant a scannable code or the merchant providing a photo of the order at the point-of-sale as validation of the order.

The present invention solves the problem of having a separate online mobile ordering methodology from a Point-of-Sale system by consolidating both online and in-person ordering processes into a uniform platform capable of accepting in-person payments, in addition to four other customizable options, namely the Ticket, Pick-Up, Near By, and At Home methods described above. The present invention unifies a Point-of-Sale system with a marketplace, system including an online bazaar having a plurality of online shops.

The present invention provides a location-based advertising feed for merchants to market their products that includes a list of individual merchant stories, each comprised of a title, caption, and photo/video, viewable on the customer app. Including a mechanism for customers to engage with and interact with the posts to develop merchant-customer engagement.

The present invention provides a customer review system to develop trust between merchants and customers that includes a customizable contact page that optionally allows a shop to provide information of their phone number, text number, or location.

The present invention provides a modularized messaging system to create an open line of communication and develop merchant-customer engagement. Underlying this messaging system is a traditional communication platform between merchant and customer. Customers may initiate conversations with shops, and merchants may engage and respond to customer questions, comments, complaints, and order inquiries. Layered onto this system is the ability for customers to inquire directly into product and order specific questions, tying in the product or order specifications into the conversation. Alternatively, customers may request a lower price on either a single product or a group of products from a particular shop, to which the merchant may choose to accept or deny.

An exemplary module of this messaging service includes a mechanism for customers to “Bargain on Bazar” and negotiate a more subjectively fair price on a good/service. This solution addresses customer price-sensitivity issues found in online peer-to-peer marketplaces.

The hybrid of the Online Pick-Up with an In-Person Standard order led to the In-Person Ticket order of the present invention. Rather than wait for everyone in a line to choose the items they want and how they would like their receipt given to them, the present invention advantageously preprocesses these components to reduce resource consumption. Since payment information is collected after the Ticket is scanned by a merchant at the Point of Sale, the present invention advantageously benefits from the fact that the merchant is not required to have the requested products in stock. In situations with high congestion and loosely know stock quantities, fulfillment success increases.

In running tests of this process, on average, about 10-30 seconds per order are saved. At scale, this is a significant quantity of time. For example, a venue that does 300 orders in a night, with average savings of 15 seconds per order, would save 75 minutes in a night. This is significant, especially considering that this process also leverages the lower in-person transaction fees. The time saved could be spent making other sales or reducing the number of employees required for the job, thus saving on costs.

Bazar is a Mobile Point of Sale and Social Marketplace. The extended metaphor afforded by the name of the product and technology platform enables merchants and customers to meet and negotiate fair prices on in-demand products beyond the virtual environment. The personal storefronts for individual merchants, with the ability to automate the process of marketing in a larger marketplace, and coupled with the ability to take orders in-person, creates the opportunity to develop hybrid online and physical retail spaces to customers.

I claim:

1. A mobile sales system, comprising:
a user device;
a merchant server;
an image acquisition device operatively connected to a point-of-sale device;
wherein the user device is configured to:
receive a user input including item selection with a merchant;
obtain user payment information;
generate a purchase transaction request including user payment information;
provide the purchase transaction request to the merchant server;
obtain an electronic purchase receipt;
generate a payment code image including information from the electronic purchase receipt; and
display the payment code image, via a display operatively connected to the user device;
wherein the image acquisition device is configured to:
acquire an image of the payment code image;
extract data from the payment code image at the point-of-sale device; and
confirm the information from the electronic purchase receipt by the point-of-sale device to complete the purchase transaction.

2. The system of claim 1, wherein the user device is a mobile device.

3. The system of claim 1, wherein the user input is a touchscreen gesture on a touchscreen operatively connected to the user device.

4. The system of claim 1, wherein the payment code is a one-dimensional barcode.

5. The system of claim 1, wherein the payment code is a two-dimensional barcode.

6. The system of claim 1, wherein the payment code is a Quick Response code.

7. The system of claim 1, wherein the merchant is an online marketplace merchant.

8. The system of claim 1, wherein the electronic purchase receipt includes a merchant identifier and a session identifier for a user shopping session with a merchant associated with the merchant identifier.

9. The system of claim 1, wherein the user payment information is associated with a virtual wallet account.

10. The system of claim 1, wherein the point-of-sale terminal is located at a physical merchant store.

11. A computer-implemented mobile sales method, comprising:
obtaining, at a user device, a user checkout request;
obtaining user shopping cart information with a merchant related to the user checkout request;
generating, via the user device, a payment code image containing information including the user shopping cart information encoded in the payment code image;
displaying the payment code image, via a display operatively connected to user device;
acquiring, by the point-of-sale device, via an image acquisition device operatively connected to the point-of-sale device, an image of the payment code image;
transforming the image into data encoded in the payment code image;
obtaining, at the point-of-sale device, user payment information;
generating, via the point-of-sale device, a purchase transaction request including the data;
providing the purchase transaction request to a server by the point-of-sale device; and
obtaining by the point-of-sale device, a notification of authorization of the purchase transaction.

12. The method of claim 11 wherein the shopping cart information includes account information.

13. The method of claim 11, wherein the step of obtaining, at the point-of-sale device, user payment information includes obtaining user payment information from the data.

14. The method of claim 11, wherein the step of displaying the payment code image includes obtaining, at the user device, a user input to display the payment code image wherein the user input is a touchscreen gesture on a touchscreen operatively connected to the user device.

15. The method of claim 11, wherein the notification of authorization of the purchase transaction includes an identifier the user shopping cart information.

16. The method of claim 11, further comprises a session identifier that includes a token parameter in a uniform resource locator for the user shopping cart information.

17. The method of claim 15, wherein the purchase payment information is associated with a virtual wallet account.

18. A mobile sales system, comprising:
a merchant server;
an image acquisition device operatively connected to a point-of-sale device;
a user device configured to receive a user request to search for a product with a merchant;
wherein the user device comprising:
a customer engagement module configured to receive a user request to view a product parameter associated with the merchant;
a messaging module configured to provide a communication channel between a user and the merchant to exchange messages associated with the product;
wherein the user device is configured to:
receive a user input including a product selection with the merchant;
obtain user payment information;
generate a purchase transaction request including user payment information;
provide the purchase transaction request to the merchant server;
obtain an electronic purchase receipt;
generate a payment code image including information from the electronic purchase receipt; and
display the payment code image, via a display operatively connected to the user device;
wherein the image acquisition device is configured to:
acquire an image of the payment code image;
extract data from the payment code image at the point-of-sale device; and
confirm the information from the electronic purchase receipt by the point-of-sale device to complete the purchase transaction, or
wherein the user device is configured to:
receive a user checkout request;
obtain user shopping cart information with the merchant related to the user checkout request;
generate a payment code image containing information including the user shopping cart information encoded in the payment code image;
display the payment code image, via the display operatively connected to the user device;
wherein the point-of-sale device is configured to:
acquire an image of the payment code image via the image acquisition device operatively connected to the point-of-sale device,
transform the image into data encoded in the payment code image;
obtain the user payment information;
generate a purchase transaction request including the data;
provide the purchase transaction request to the merchant server;
obtain a notification of authorization of the purchase transaction; and
obtain an electronic purchase receipt for the purchase transaction.

19. The system of claim 18, wherein the user is enabled to search for the product based on the product category, product tags, product popularity, and product features.

20. The system of claim 18, wherein the product parameter is at least one of a product image, product video, product information, product stories, product price, likes, dislikes and comments on the product.

21. The system of claim 18, wherein the customer engagement module enables the user to like, dislike and/or comment on the viewed product.

22. The system of claim 18, wherein the messaging module is configured to provide the communication channel between the user and the merchant to exchange messages associated with the product price, user's past orders, complaints, questions related to the product, or any other product related query.
